(19) United States
(12) Patent Application Publication
(10) Pub. No.: US 2025/0004722 A1
(43) Pub. Date: Jan. 2, 2025

(54) METHOD FOR GENERATING A PSEUDORANDOM NUMBER AND METHOD FOR SYMMETRICALLY ENCRYPTING A MESSAGE

(71) Applicant: CYFERALL, Montigny-le-Bretonneux (FR)

(72) Inventor: Jean-Louis Olie, Viroflay (FR)

(73) Assignee: CYFERALL, Montigny-le-Bretonneux (FR)

(21) Appl. No.: 18/698,436

(22) PCT Filed: Oct. 10, 2022
(86) PCT No.: PCT/EP2022/078024

§ 371 Date: Apr. 4, 2024

(30) Foreign Application Priority Data
Oct. 8, 2021 (FR) 2110513

(51) Int. Cl. G06F 7/58

(52) U.S. Cl. CPC G06F 7/582

(57) ABSTRACT

The invention relates to a computer-implemented method for generating at least one pseudorandom number, comprising: obtaining an initiation value (102), K, with a certain entropy represented by its bit length; executing a one-way hash function (100), H, adapted for a certain bit length, on the starting value and then on the successive values of a series of at least one element, in which the pseudorandom number (104), Mᵢ, is represented by H(Mᵢ₋₁), with i>0, and M₀=K. Other aspects of the invention comprise a method for encrypting a message, a method for encrypting a data flow and a symmetrical encryption method.

This invention relates to computer-implemented methods for generating a pseudorandom number and to a method for symmetrically encrypting a message.

### PRIOR ART

It is very common to want to protect information exchanges. This protection is based on the encryption of messages, such as text, voice and images, exchanged between a sender and a receiver.

The entire process is called “end-to-end encryption” if the message is encrypted from the sender to the recipient(s) without being intelligible for the servers or other services involved in routing the message. Only the sender of the message and the intended recipients must be able to see the unencrypted content.

The only tamper-evident symmetric encryption method known and mathematically demonstrated is the “One Time Pad” (OTP) method. This method is unbreakable by any computer. However, its implementation requires compliance with very stringent conditions, which has so far discouraged its use as a basis for symmetric encryption of long messages.

OTP encryption is inherently indecipherable, regardless of the computing power used, and therefore, as a rule, it has an infinite level of security. A message of length n bytes is masked using an XOR operation with the bytes of a mask of the same length n. To decrypt the hidden message, the same XOR operation must be carried out again, which requires the mask. This mask cannot be calculated, and there are as many possible masks as there are intelligible messages (in all possible languages) of the same length n, with no possibility of guessing which one is the right one. Message length is the only information available to an attacker who does not have the mask, regardless of the available computational power. The same mask must not be reused, because if an attacker had knowledge, by whatever means, of the encrypted and decrypted versions of a message, they would be able to calculate the mask by carrying out the XOR operation between the two versions and to reuse the mask for subsequent messages encrypted with the same mask. The major disadvantages of the OTP method are that the recipient must also have the mask to decrypt the message, that this mask is as long as the message and therefore just as difficult to send securely, and that it must be different every time.

As such, the OTP symmetric key encryption method cannot be used in practice.

Other symmetric encryption methods have been developed and some have been standardized, such as the Advanced Encryption Standard (AES). These algorithms are not tamper-proof. In the case of AES, which is the most commonly used, this algorithm is susceptible to auxiliary channel attacks. Moreover, in its most robust version with 256-bit key length, its resistance to brute force attacks from quantum computers will be insufficient, as a minimum of 512 bits is required. In fact, due to the potential use of the Grover algorithm on a quantum computer as described in Grover L. K.: A fast quantum mechanical algorithm for database search, Proceedings, 28th Annual ACM Symposium on the Theory of Computing, (May 1996) p. 212, the level of security against the risk of breaking AES-256 by brute force is reduced from 256 bits to 256/2=128 bits. For encrypting real-time data streams, specific algorithms were produced with AES as an underlying algorithm. These are the Gallois Counter Mode (GCM) and the Offset Codebook Mode (OCB). In addition to the AES drawbacks discussed earlier, these two modes introduced additional weaknesses. A more recent version of AES-GCM, AES-GCM-SIV, corrects the AES-GCM weaknesses to some extent (reference: “Gueron, S. (April 2019), AES-GCM-SIV: Nonce Misuse-Resistant Authenticated Encryption: IETF: doi: 10.1748/FRC8452”) but at the cost of a significant deterioration in performance.

The present invention aims to remedy one or more of the disadvantages associated with the prior art.

### SUMMARY OF THE INVENTION

In accordance with the present inventions, a computer-implemented method is provided for generating at least one pseudorandom number, comprising: obtaining a boot value, K, of a certain entropy represented by its bit length; combining, using an XOR operation, the boot value, K, with a pseudorandom nonce, N, of the same bit length s, the combination represented by (K\hat{ }N) wherein \hat{ } is an XOR operation; and running a one-way hash function, H, adapted to the bit length on the combination (K\hat{ }N) to generate a value, M′₀, wherein the pseudorandom number M′ᵢ₊₁ is calculated according to H(M′i), wherein 0≤i<n−1.

This method is a practical and robust way to provide a pseudorandom number. In addition, this process and any other process based on its implementation are resistant to auxiliary channel attacks. The XOR operation is carried out with a constant number of clock cycles, irrespective of the values of K and N. This operation therefore cannot be subject to auxiliary channel attacks based on statistical analysis of the calculation times or power consumption required for this calculation if this process is repeated a large number of times with the same K key, since these calculation time and power consumption data remain constant.

A nonce, which can also be called a cryptographic nonce, is an arbitrary number that can only be used once in a cryptographic communication. The function H(K\hat{ }N) can be called HXOR, where it is defined by HXOR(K, N)=H(K\hat{ }N).

Advantageously, the method comprises producing a sequence of pseudorandom masks Mᵢ using a sequence of pseudorandom numbers M′ᵢ and the nonce N for generating the pseudorandom numbers, according to the expression Mᵢ=H(M′ᵢ\hat{ }N), wherein 0≤i<n.

The present invention further relates to a method for encrypting a message, P, comprising the following steps: splitting the message, P, into n equal parts, Pᵢ, wherein 0≤i<n, of the chosen bit length s; combining each part, Pᵢ, with the mask, Mᵢ of the same bit length s, wherein 0≤i<n, to form an encrypted part, C₀ to Cₙ₋₁, for each part; and concatenating the nonce N and the encrypted parts, C₀ to Cₙ₋₁ to form an encrypted message, C, in which each mask, M₀ to Mₙ₋₁, is a pseudorandom number generated according to the method for generating a pseudorandom number.

The combination also includes an XOR operation.

According to one feature, the method comprises the creation of a signature, S, for the encrypted message C.

Advantageously, the method comprises calculating the signature, S, according to HMAC(Sₙ₋₁, M′ₙ), wherein sₙ₋₁ is the nth value in a sequence calculated according to sᵢ₊₁=Sᵢ\hat{ }Pᵢ₊₁, wherein 0≤i<n, S₀ is P₀ and wherein M′ₙ is n+1th value in the sequence of pseudorandom numbers M′ᵢ.

Alternatively, the method comprises calculating the signature, S, according to HXOR(Sₙ₋₁, N), wherein sₙ₋₁ is the nth value in a sequence calculated according to sᵢ₊₁=Sᵢ\hat{ }Pᵢ₊₁, wherein 0≤i<n, S₀ is P₀ and N is the nonce.

The encryption method also comprises attaching the signature, S, to the encrypted message, C, to form a signed encrypted message, T.

The present invention further relates to a method for decrypting the encrypted message C, produced according to claim 3 comprising retrieving the nonce N and the encrypted parts, C₀ to Cₙ₋₁ of the encrypted message C, calculating the masks according to claim 2; decrypting each encrypted part C₀ to Cₙ₋₁, together with the boot value, K and the nonce N, to form the equal parts, P₀ to Pₙ₋₁; and combining the parts P₀ to Pₙ₋₁ to form the message P.

The present invention further relates to a method for encrypting a data stream F, comprising: slicing the data stream F into packets Pᵢ, of bit length s, with i≥0; sending a pseudorandom nonce N in the encrypted stream ES; encrypting each packet Pᵢ, wherein an encrypted packet C₂ᵢ=(Pᵢ\hat{ }M₂ᵢ) and C₂ᵢ₊₁=(Pᵢ\hat{ }M₂ᵢ₊₁), wherein Mᵢ is the sequence of pseudorandom masks Mᵢ according to claim 2; concatenating the number i with to form C₂ᵢ and C₂ᵢ₊₁ to form the encrypted version (i| C₂ᵢ|C₂ᵢ₊₁); and sending the encrypted version in the encrypted data stream ES.

The present invention further relates to a method for decrypting an encrypted data stream ES, produced according to claim 8, comprising: retrieving the nonce N at the start of sending the encrypted data stream ES, allowing calculation of the suites Mᵢ and M′ᵢ according to claim 2; decrypting each encrypted version (i|C₂ᵢ|C₂ᵢ₊₁) into Dᵢ=C₂ᵢ\hat{ }M₂ᵢ; and checking the integrity by establishing that Dᵢ=M₂ᵢ₊₁\hat{ }C₂ᵢ₊₁, with the certainty that Dᵢ=Pᵢ, if this check is positive.

Advantageously, if s≥512, the hash function, H, has a quantum security level of more than 170 bits with respect to its inversion.

According to one feature, the hash function, H, is a Keccak hash function.

According to another feature, the chosen bit length is 512 bits.

The present invention further relates to a computer-implemented method for symmetric encryption using a K key, comprising: obtaining a pseudorandom nonce N for each plaintext message P to be encrypted, each nonce having the same bit length s as the K key; combining, using an XOR operation, the K key with the nonce, N, the combination represented by (K\hat{ }N) wherein \hat{ } is an XOR operation; running a one-way hash function, H, adapted to the bit length on the combination (K\hat{ }N) to generate a modified key, K′; encrypting the message P using the modified key, K′; and concatenating the nonce N with the result of this encryption to form the encrypted message C.

Such a method is resistant to auxiliary channel attacks.

The present invention further relates to a computer-implemented method for symmetrically decrypting the encrypted message C according to claim 14, comprising: obtaining the pseudorandom nonce N of the encrypted message C; combining, using an XOR operation, the K key with the nonce, N, the combination represented by (K\hat{ }N) wherein \hat{ } is an XOR operation; running the one-way hash function, H, on the combination (K\hat{ }N) to generate the modified key, K′; and decrypting the encrypted message C using the modified key, K′, to obtain the plaintext message P.

Within the scope of this application, it is expressly provided that the various aspects, embodiments, examples and variants disclosed in the preceding paragraphs, in the claims and/or in the following description and drawings, and in particular the individual features thereof, can be taken alone or in combination. This means that all embodiments and/or features of any embodiment can be combined in any way and/or combination, unless these features are incompatible. The applicant reserves the right to amend any claim originally filed or to file any new claim accordingly, including the right to amend any claim originally filed to depend on and/or incorporate any feature of any other claim even though it was not originally claimed in this manner.

### BRIEF DESCRIPTION OF THE FIGURES

Various embodiments of the invention are described below with reference to the attached drawings, in which:

FIG. 1(a) is a flow chart of a method for generating a pseudorandom number according to the disclosure;

FIG. 1(b)—is a flow chart of a method for generating a sequence of pseudorandom numbers according to the disclosure;

FIG. 2(a) is a flow chart of another method for generating a pseudorandom number according to the disclosure;

FIG. 2(b) is a flow chart of another method for generating a sequence of pseudorandom numbers according to the disclosure;

FIG. 3 is a flow chart of another method for generating a pseudorandom number according to the disclosure;

FIG. 4 is a flow chart of a method for encrypting a message according to the disclosure;

FIG. 5 is another flow chart of the method for encrypting a message according to the disclosure;

FIGS. 6 (a) and (b) are flow charts of the methods for calculating a signature for a message according to the disclosure;

FIGS. 7 (a) and (b) are diagrams of the principle of messages encrypted according to the disclosure;

FIGS. 8 (a), (b) and (c) are flow charts of a method for encrypting a data stream of packets with integrity checking of each packet according to the disclosure;

FIG. 9(a) is a flow chart of a known symmetric encryption process;

FIG. 9(b) is a flow chart of a known symmetric encryption process according to the disclosure; and

FIG. 10 is a block diagram of a computing device.

### DETAILED DESCRIPTION

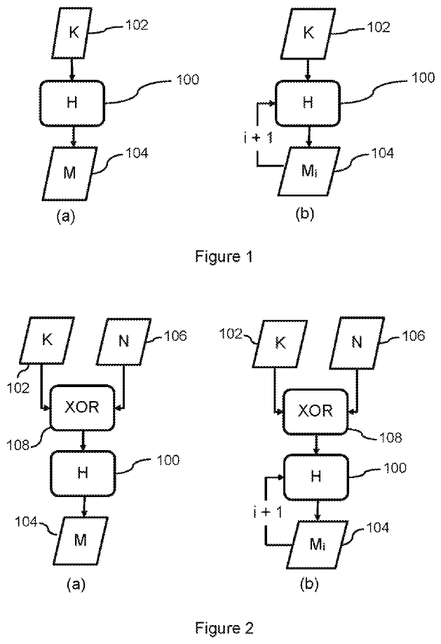

FIG. 1(a) shows a flow chart of a method for generating a pseudorandom number using a hash function, H, 100. The hash function, H, 100, inputs a key, K, 102 of a certain bit length s, which serves as the process boot value, and converts it into a pseudorandom number, M, 104 of the same bit length. The hash function, H, 100 can be a good quality, one-way hash function, such as the Keccak hash function. FIG. 1(b) shows a flow chart, representing a change in the method illustrated in FIG. 1(a), which generates a sequence of pseudorandom numbers. In FIG. 1(b), the pseudorandom number generated by the hash function, H, 100, is fed back into the hash function, H, 100, as the starting value. In this way, the sequence of pseudorandom numbers, Mᵢ, can be represented by H(Mᵢ₋₁), wherein i>0, and M₀=K. All Mᵢs will retain the same level of entropy of the information as the boot value, K, 102. Although this process is entirely deterministic, the characteristics of the H, 100 function, recalled above, imply that the all-order autocorrelation levels of the Mᵢ sequence remain close to zero due to the uniformity of the probability density of the H, 100 values, as long as no Mᵢ value is an H, 100 collision value. If the H, 100 function is of good quality, the probability of this occurring remains very low. Moreover, knowledge of one or all of the Mᵢ values does not make it possible to determine the K key, 102 with a level of security equal to the bit length of the hash function for a conventional deterministic computer.

Referring to FIG. 2(a), an alternative method for generating a pseudorandom number is shown, wherein the key, K, 102 is first combined with a pseudorandom nonce, N, 106 of the same bit length. A nonce is an arbitrary number used only once in a cryptographic communication. The entropy level of the value N, 106 has no effect on the entropy level of the constructed sequence of pseudorandom numbers. The K key, 102 and the nonce N, 106 can be combined using an XOR operation, 108. According to the method illustrated in FIG. 1, the output, M, of the hash function, H, 100, is a pseudorandom number 104 equal to HXOR(K, N). In FIG. 2(b), the output, Mᵢ, of the hash function, H, 100 can be fed back into the hash function, H, 100 to create a sequence of pseudorandom numbers. In this way, the sequence of pseudorandom numbers, Mᵢ, can be represented by H(Mᵢ₋₁), wherein i>0, and M₀=K\hat{ }N. In addition to the process properties in relation to FIG. 1, the process of this alternative method makes it possible to repeat this process with another value of N, 106 if a collision were to appear in the calculation of the Mᵢ sequence, and to generate, with the same boot value K, 102, multiple sequences with different values of N, 106. The level of correlation between these different sequences, like the level of autocorrelation of each sequence, remains close to zero due to the properties of the hash function H, 100. However, the Mᵢ suite is not entirely compartmentalized. A suite of pseudorandom numbers is said to be fully compartmentalized if the knowledge of a value Mᵢ in this suite does not allow us to deduce any other value Mⱼ, with j≠i, in this suite. In the suite of pseudorandom numbers described above, knowledge of Mᵢ does not make it possible to deduce any of the Mⱼs with 0≤j<i, nor the K key, but all of the Mⱼs with j>i can be deduced from Mᵢ. To use a suite of pseudorandom numbers to mask a message to be encrypted while preserving the mathematical tamper-proof properties of the OTP, it must be ensured that the masking process is indistinguishable with regard to adaptive attacks with selected cipher texts (IND-CCA2). To achieve this, the no-autocorrelation property is not sufficient, and the suite must also be fully compartmentalized.

The first operation in the process shown in FIGS. 2(a) and 2(b) is the XOR operation between the K key and the nonce N. This operation is carried out with a constant number of clock cycles, irrespective of the values of K and N. This operation therefore cannot be subject to auxiliary channel attacks based on statistical analysis of the calculation times or of the power consumption required for this calculation if this process is repeated a large number of times with the same K key, since these calculation time and power consumption data remain constant. Moreover, if the nonce N is different each time this process is repeated, the result of this first operation is also different each time. As a result, even if the K key remains constant, the rest of the process beyond this first operation has as its input value a datum that is different each time, and statistical analysis of calculation times or power consumption for the rest of the process cannot reveal any value that would remain constant in the repetition of the process. Overall, the process is therefore resistant to auxiliary channel attacks. Any other process based on the implementation of this procedure will thus also be resistant to auxiliary channel attacks.

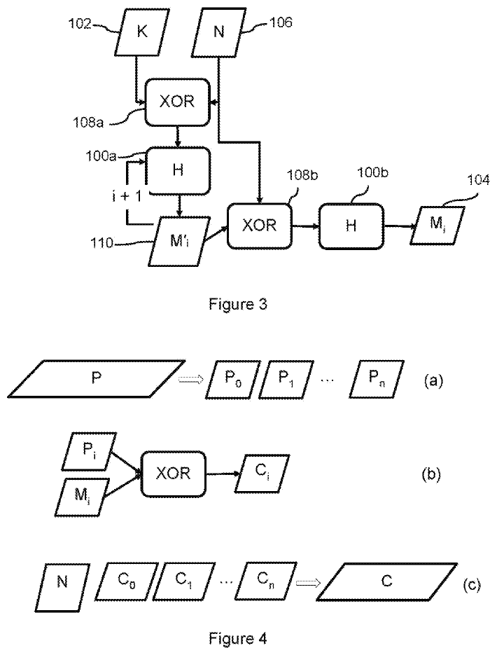

With reference to FIG. 3, a flow chart depicting another method for generating a sequence of pseudorandom numbers is shown, using a sequence of intermediate pseudorandom numbers. The generated sequence is fully compartmentalized. The method in FIG. 3 is similar to the one in FIGS. 2(a) and (b) in that a key, K, 102, of a certain bit length s is combined, using an XOR function 108a, with the pseudorandom nonce, N, 106, of the same bit length s, the output being subjected to the hash function, H, 100a, to generate an intermediate pseudorandom number, M′, 110. The intermediate pseudorandom number, M′, 110, is combined with the nonce, N, 106, using an XOR operation 108b, the result being fed into another hash function, H, 100b, to output the pseudorandom number, M=HXOR(M′, N). By feeding each intermediate pseudorandom number, M′, 110, back through the hash function, H, 100a, to create the next intermediate pseudorandom number M′ᵢ in the sequence, a sequence of n pseudorandom numbers can be created. Thus, the first intermediate pseudorandom number M′₀ is calculated according to HXOR(K, N), and M′ᵢ₊₁ is calculated according to H(M′ᵢ), wherein 0≤i<n−1. The sequence of intermediate pseudorandom numbers can then be combined with the nonce, N, 106, to generate the pseudorandom numbers, according to the expression Mᵢ=HXOR(M′ᵢ, N), wherein 0≤i<n. In addition to the process properties in relation to FIGS. 1 and 2, this alternative process has the property of not allowing the M; and subsequent values in the sequence to be calculated from the sole knowledge of N, 106 and the Mᵢ values for 0≤i<j. This new suite Mᵢ of pseudorandom numbers is therefore fully compartmentalized.

FIG. 4 shows a flow chart illustrating a method for encrypting a message. The message is represented by a block P. In FIG. 4(a), the message P is split into a number n of equal parts, P₀ to Pₙ₋₁, of the chosen bit length s. The message P can be supplemented with additional padding bits to bring it up to the bit length required to enable it to be split into equal parts of a particular chosen bit length. In one example, the chosen bit length is 512 bits. In FIG. 4(b), each part, Pᵢ, of the message is combined with a pseudorandom mask, Mᵢ, from a sequence of masks of the same chosen bit length s, using an XOR operation, to form an encrypted part, C. In FIG. 4(c), the nonce N and the encrypted parts are then concatenated together to form an encrypted message, C. The masks, M₀ to Mₙ₋₁, can be pseudorandom numbers generated according to any of the methods in FIGS. 2 and 3, as the method in FIG. 1 does not enable a different mask to be used for each message.

In this way, symmetric One Time Pad encryption can be provided as a secure and cost-effective way of encrypting transmitted information, but with a reduced level of security relative to infinity. In one example in which the chosen bit length is 512 bits and the method is as shown in FIG. 3, the security level is 512 bits with respect to attacks originating from conventional computers and three times smaller for those originating from quantum computers (170 bits).

Since mask calculation is entirely separate from the message to be encrypted itself, for data streams where reducing information transmission latency could be an issue, frame production and mask construction can be two processes run in parallel. Latency is therefore only penalized by the XOR operation, which is one of the fastest operations that can be carried out on a computer. This is a clear advantage over other symmetric encryption algorithms, such as AES 256, where the message to be encrypted must be available before the encryption operations begin, since the latter are much longer than a simple XOR.

For the one-way hash function, the Keccak algorithm, as described by Guido Bertoni, Joan Daemen, Michael Peeters, Gilles Van Assche and Ronny Van Keer in “KANGAROO Twelve: fast hashing based on KECCAK-p (International Association for Cryptologic Research, 2016”), has a 512-bit security level against attacks originating from conventional computers. The security level with regard to attacks originating from quantum computers was determined by Gilles Brassard, Peter Hoyer and Alain Tapp in “Quantum cryptanalysis of hash and claw-free functions, Springer, 2006”, and is equal to 512/3 is equal to around 170.

If the entropy of the information for the boot value K is 512 bits, all Mis will retain the same entropy level, namely 512 bits, if the likelihood of a collision, when applying the H function to Mᵢ₋₁ remains sufficiently low.

The use of pseudorandom numbers generated by the method described in relation to FIG. 3 prevents the decryption of a message block if an attacker has somehow obtained the plaintext and ciphertext of a previous message block. In this way, it is possible to withstand attacks at a level of indiscernibility under an adaptive attack using chosen ciphertext (IND-CCA2).

In order to take full account of an IND-CCA2 level attack, it is necessary to ensure that the acquisition, by any means, of the encrypted and decrypted versions of a block of the message P does not allow the subsequent blocks of the same message to be decrypted. In this respect, the calculation of the mask sequence must be consistent with the method in relation to FIG. 3 by constructing two sequences Mᵢ and M′ᵢ as follows, while using the fully compartmentalized sequence Mᵢ to mask the information Pᵢ: M′₀=HXOR(K, N), M′ᵢ₊₁=H(M′ᵢ), for any i such as n−1>i≥0 and Mᵢ=HXOR(M_{′i}, N), for any i such as n>i≥0.

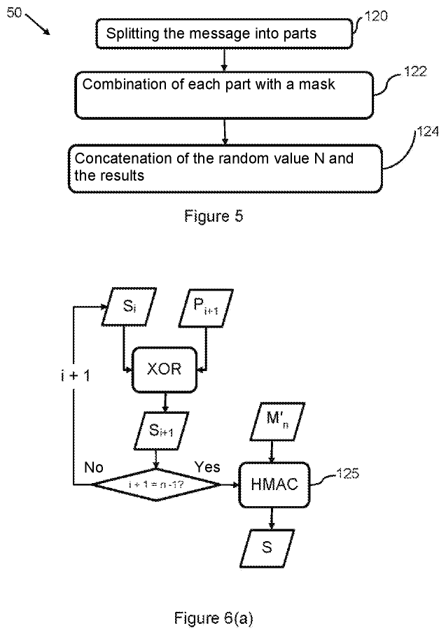

With reference to FIG. 5, another flow chart is shown illustrating the method 50 for encrypting a message, such as message P in FIG. 4. The method 50 comprises splitting the message at block 120 into equal parts of a certain bit length. The message can be supplemented with additional bits if needed. At block 122, each of then parts of the message is combined using an XOR operation with a sequence of masks of the same bit length, such as the M-mask in FIG. 4, to form encrypted parts. Then, at block 124, the method comprises concatenating the nonce N and the masked parts into an encrypted message.

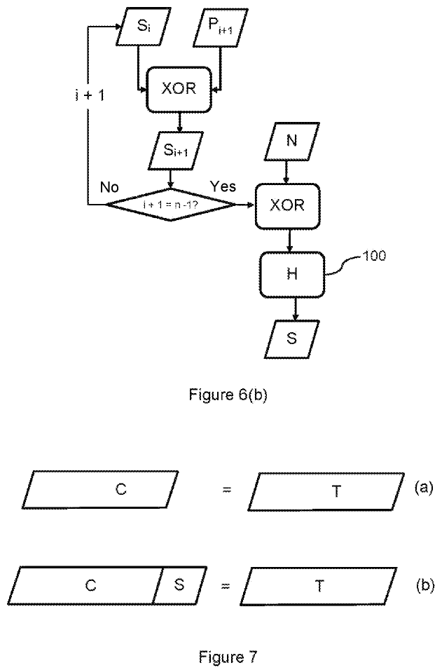

Referring now to FIG. 6(a), a flow chart of a method for generating a signature, S, for the encrypted message is shown. The use of a signature makes it possible to check the integrity of the information after sending. The signature, S, can be attached to the encrypted message. The signature to be attached to the encrypted message is the nth value of a sequence calculated from an XOR operation carried out on a part, Pᵢ₊₁, of the message with the previous value of the signature sequence, Sᵢ. When the final value (the nth value) is calculated, a hash function, H, is run on that final value to generate the signature. Thus, in accordance with FIG. 6(a), the signature, S, can be calculated according to HMAC(Sₙ₋₁, M′ₙ), where M′ₙ=H(M′ₙ₋₁), sₙ₋₁ is the nth value in a sequence calculated according to sᵢ₊₁=Sᵢ\hat{ }Pᵢ₊₁, wherein 0≤i<n−1, and S₀ is P₀. HMAC(m, k) 125 is a keyed hash function for integrity checking, calculating a result from a message m and from a K key. Alternatively, the signature S can be calculated according to HXOR(Sₙ₋₁,N) in accordance with FIG. 6(b), but this method, which takes less time to calculate, is not standardized like RFC 2104 for HMAC.

Referring now to FIG. 7, block diagrams are shown for encrypted messages that can be created using the methods of the invention. FIG. 7(a) shows an encrypted message, C, formed from the combination of the masked parts with the nonce N. Using the pseudorandom number generation described in relation to FIG. 2 or 3, the mask is rendered disposable by the fact that the pseudorandom nonce N and accordingly the sequence of masks Mᵢ are different for each message. The methods in FIGS. 2 and 3 guarantee that with knowledge of both the plaintext and ciphertext versions of a message the mask could not be calculated with a quantum security level of 170 bits, which is that of inverting the hash function with a quantum computer. The encrypted message then becomes, C=N|(P₀\hat{ }M₀)|(P₁\hat{ }M₁)|(P₂\hat{ }M₂) . . . |(Pₙ₋₁\hat{ }Mₙ₋₁₎, because N is necessary for decryption but can be freely sent without compromising security. Only the method in FIG. 3 makes it possible to withstand IND-CCA2 attacks with this level of security. In the message encryption process in FIG. 7 (a), the sent message T is simply identical to the encrypted message C.

FIG. 7(b) shows an encrypted message C formed as in FIG. 7(a) from the combination of the masked parts with the nonce N. It also shows an S signature calculated according to the process described in FIG. 6. The sent message T is the signed message combining C with S.

For decryption, if T=N|C₀|C₁|C₂ . . . |Cₙ|S is the encrypted message, optionally signed if S is present, and if the recipient has the K key, he can reconstruct the M′ᵢ and Mᵢ sequences with the same formulas as before, construct the decrypted message D=(C₀\hat{ }M₀)|(C₁\hat{ }M₁)|(C₂\hat{ }M₂) . . . |(Cₙ₋₁\hat{ }Mₙ₋₁). If the message is signed, the recipient can also reconstruct the signature S′=HMAC(Sₙ₋₁, M′ₙ) with S′₀=D₀, S′ᵢ₊₁=S′ᵢ\hat{ }Dᵢ₊₁, for any i such as n−1>i≥0. Alternatively, as seen above, this signature could be reconstructed according to S′=HXOR(Sₙ₋₁, N).

In the case of a signed message, the integrity check can be done by testing equality S=S′, with a very high likelihood that Dᵢ=Pᵢ, for any i such as n>i≥0, if the test is positive.

To encrypt and decrypt, with or without checking integrity, the plaintext message P of any length, it is sufficient to have previously exchanged, using a signed asymmetric encryption method, a K key of a certain bit length s, for example 512 bits, constructed in such a way as to ensure an entropy level of 512 bits, then to encrypt each of the messages with a different value of the nonce N. In OTP encryption, the fact that the security level is infinite stems from the fact that there are no selection criteria for deciding which of the potential masks corresponds to the encryption chosen by the sender. In the embodiments of the invention, this criterion exists whenever the message has more than one block or is signed. If the message is unsigned but contains several blocks, the criterion will be, when trying a K key, that all the decrypted blocks are simultaneously “intelligible” in at least one language. If the message is signed, the criterion will simply be that for the K key attempted, the result is S=S′. The security level is therefore not infinite, but decrypting without the key means exploring 2⁵¹² possibilities for a K key and a 512-bit hash function. This colossal number, of the order of magnitude of the square of the number of atoms in the universe, makes decryption impossible in practice, even with an attack mechanism using a quantum computer, for which the security level is reduced from 512 to 170.

If the pseudorandom nonce N is inadvertently reused to encrypt two plaintext messages P and P′, the consequences will be very limited. If the attacker has found that the nonce N has been reused and knows the encrypted and decrypted versions of P, and that P has n blocks, he will be able to find the decrypted version of the first n blocks of P′, but this will be the only possible breach. The K key can never be recreated to decrypt other messages, and if P′ has more blocks than P, the last blocks cannot be decrypted. More precisely, the only blocks of P′ that can be decrypted are the ones for which the encrypted and decrypted versions of the same sequence number of P are known to the attacker. Because of this extremely substantial limitation, an encryption process whose mask sequence calculation is based on FIG. 3 of the present inventions can be considered a process that is resistant to nonce reuse. Moreover, with a nonce N of length s bits with s≥512, if the pseudorandom nonce drawing process is initialized with an entropy of s bits, the likelihood of inadvertent reuse of a nonce value is in practice zero.

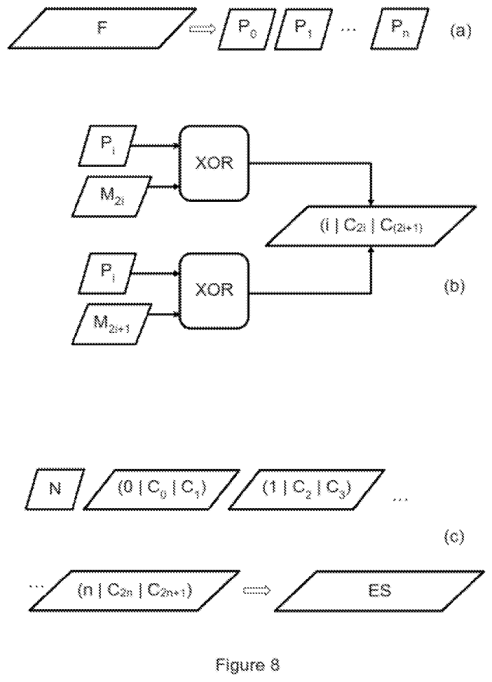

Referring to FIG. 8, flow charts are shown illustrating the process of encrypting a stream of data packets. In cases where the message to be encrypted is a stream of packets of bits or data, each packet being relatively short but the number of packets potentially very large, as in the case of real-time audio or video streams, it is not possible to wait until the message has finished sending to check its integrity, and it is desirable to check this integrity at the level of each individual packet. In this case, the encryption process can be adapted to a stream organized in successive packets of s Pᵢ bits, with i≥0. The nonce N alone is then the first packet sent in the encrypted stream, then each packet Pᵢ, i≥0 is sent in the form (i|C₂ᵢ|C₂ᵢ₊₁)=i|(Pᵢ\hat{ }M₂ᵢ)|(Pᵢ\hat{ }M₂ᵢ₊₁), with the suites of pseudorandom numbers Mᵢ and M′ᵢ calculated as before. The fact that each Pᵢ packet is encrypted twice with two different masks makes it possible to ensure the integrity check of this packet upon decryption.

The process illustrated in FIG. 8 encrypts and decrypts a stream of packets, checking the integrity of each packet. Referring to FIG. 8(a), the stream F is sliced into packets Pᵢ of length s bits, with i≥0. Referring to FIG. 8(b), each packet Pᵢ is masked twice with the XOR function, the first time with mask M₂ᵢ and the second with mask M₂ᵢ₊₁. Referring to FIG. 8(c), these two masked versions C₂ᵢ and C₂ᵢ₊₁ are then concatenated with the index i in (i|C₂ᵢ|C₂ᵢ₊₁) to form the encrypted form of the packet. Sending the index i ensures that the calculation of suites Mᵢ and M′ᵢ remains synchronized during decryption, in case certain packets are lost in the transmission of the encrypted stream. The nonce N is sent as the first element of the encrypted stream ES.

Each encrypted form of the packet (i|C₂ᵢ|C₂ᵢ₊₁) can be decrypted in Dᵢ, with Dᵢ=M₂ᵢ\hat{ }C₂ᵢ and the integrity check consists of verifying that Dᵢ=M₂ᵢ₊₁\hat{ }C₂ᵢ₊₁ as well. If this verification is positive, then Dᵢ=Pᵢ, this time with certainty and not just with a very high probability.

Expressed as the number of clock cycles required to decrypt each packet of s bits with integrity checking, this process results in lower latency than AES alone, AES-GCM or AES-OCB, without the same security weaknesses. Thus, with 64-bit processors, to decrypt a 512-bit packet with integrity checking, due to the complete decorrelation between mask calculation and decryption process, the process covered by the present inventions requires only 24 clock cycles with a single-core processor (16 cycles for decryption and 8 cycles for comparison), whereas AES256 alone requires 1,610 clock cycles (reference: Schneier, Bruce; Kelsey, John; Whiting, Doug; Wagner, David; Hall, Chris; Ferguson, Niels (1999 Feb. 1), Performance Comparisons of the AES submissions), AES256-OCB and AES256-GCM require over 80 cycles, AES256-GCM-SIV over 170 (reference: Krovetz, Ted and Rogaway, Philip, The Design and Evolution of OCB. Journal of Cryptology, Jul. 27, 2021. https://link.springer.com/content/pdf/10.1007/s00145-021-09399-8.pdf). Similar to the message encryption process described above, the stream encryption process covered by these disclosures can be considered resistant to inadvertent reuse of the nonce.

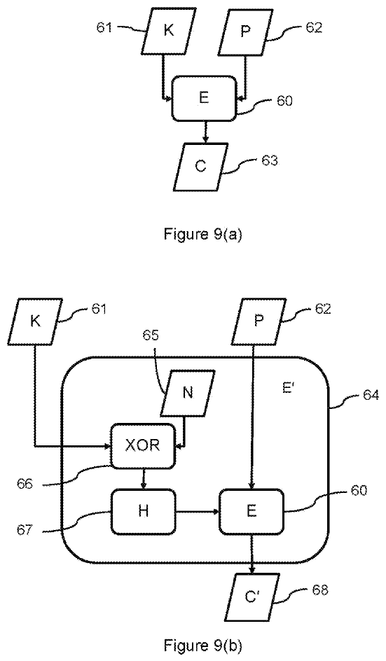

FIG. 9(a) shows a flow chart of a known symmetrical encryption method E, 60, producing an encrypted message C₁₋₆₃, from a plaintext message P, 62 and a K key, 61. This symmetrical E, 60 encryption process is potentially susceptible to auxiliary channel attacks. An E algorithm may be susceptible to auxiliary channel attacks since it always processes messages with the same key, and since the runtime and/or the corresponding power consumption depend on this constant factor, statistical processing of the data can make it possible to extract this constant factor by eliminating the variable part linked to the messages processed and thus extracting the bits from the key (see the reference “Bernstein, Daniel J., Cache-timing attacks on AES, https://cr.yp.to/antiforgery/cachetiming-20050414.pdf”, with regard to AES).

To make the E algorithm impervious to auxiliary channel attacks, the function HXOR defined as HXOR(K, N)=H(K\hat{ }N) can be considered, wherein s is the number of bits in the K key, N is a pseudorandom nonce of the same bit length s and which will be different for each message to be encrypted P, \hat{ } is the XOR operation and H is a one-way hash function producing a result of s bits in length. The converted E′ algorithm is then defined by C′=E′(P, K)=N|E(P, HXOR(K, N)), | being the concatenation operation and N being a randomly chosen, but different, nonce for each message P to be encrypted. Due to the properties of the hash function H, sending N in plaintext in C′ does not allow the K key or the P message to be compromised.

FIG. 9(b) shows a flowchart of a symmetric encryption process according to the disclosure. The process in FIG. 9(b) is able to withstand these auxiliary channel attacks. As shown in this figure, prior to the encryption of a plaintext message P, 62, a nonce N, 65, with the same bit length s as the K key, 61, of the process E, 60, is randomly selected. The nonce N, 65 has a different value for each plaintext message P. The K key, 61 and the nonce N, 65 are then combined using an XOR operation, 66. The hash function H, 67 is applied to the result of this combination. The product of this set of operations is the result of the function HXOR(K, N) as defined above. This product can be called a modified key, K′, and is used as the key for the encryption process E instead of the K key. The nonce N is concatenated with the product of the encryption process E, to form the encrypted message C′, 68, of the converted process E′, 64.

For decryption, the nonce N 65 is obtained from the encrypted message C′, 68. The modified key can then be derived from the nonce N and the K key 61 in the same way as described above with respect to encryption. The encrypted message C′, 68, can then be decrypted, using the modified key, to obtain the plaintext message P 62.

The converted E′ algorithm described above is not susceptible to auxiliary channel attacks. In fact, since the first operation carried out for encryption or decryption is the XOR operation on s bits, which always requires the same number of clock cycles to be run, this operation in itself is not subject to auxiliary channel attacks. All of the subsequent operations in the hash function H and then in the E algorithm have runtimes and power consumption that depend on the result of this XOR function but since N is different at each encryption, the variability of this result cannot be distinguished from that of the messages processed and, since the result is no longer a constant, no auxiliary channel attack based on statistical analysis of the runtimes or power consumption of H and/or E will be able to find the bits in the K key. Even if the nonce N is inadvertently reused a few times and the attacker detects this, no statistical processing will be possible if the number of reuses remains low. The method covered in these disclosures can therefore be considered resistant to the reuse of the nonce. It will be understood that these advantages apply to other methods using the function described herein.

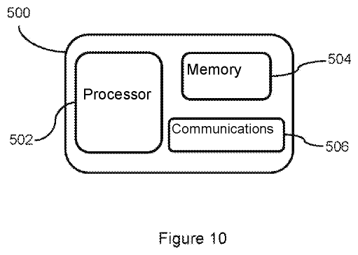

Referring now to FIG. 10, a block diagram is shown of a computing device that can be used to implement the methods disclosed above. The computing device 500 comprises a memory 504 adapted to store data and operating instructions and a processor 502 adapted to process the operating instructions so as to run functions comprising the disclosed methods. The computing device 500 further comprises a communication module 506 adapted to send and receive messages, including encrypted messages such as those shown in FIG. 7, to one or more other computing devices (not shown).

The processes in the embodiments of the invention are based on the use of a hash function H. If I is the interval [0, 2^{s}−1] of natural numbers, of cardinal 2^{s}, a hash function of s bits in length is a function of I in I such that the likelihood for any X that H(X) is equal to a given value Y is equal to ½^{s}. If the only known method of inverting the hash function is to browse the list of 2^{s} values of I, the hash function is said to be one-way and the security level of the inversion is equal to s bits for a conventional deterministic computer. If a value C in | is equal to C=H(C), C is a collision value of H. If n_{c} is the number of collision values in I, the quality of the hash function is measured by the fact that the probability density of the H values is uniform over | and that the likelihood of a collision, equal to n_{c}/2^{s}, remains very low.

Throughout the description and claims of this specification, the words “understand” and “contain” and their variations mean “including but not limited to” and are not intended for (and do not exclude) other parts, additives, components, integers or steps. Throughout the description and claims of this specification, the singular includes the plural, unless the context requires otherwise. In particular, when the indefinite article is used, the specification must be understood as envisaging plurality as well as singularity, unless the context requires otherwise.

Features, integers, characteristics, compounds or groups described in connection with a particular aspect, embodiment or example of the invention are to be understood as applicable to any other aspect, embodiment or example described herein, unless inconsistent therewith. All of the features disclosed in this specification (including the claims, abstract and accompanying drawings), and/or all of the steps of a method or process thus disclosed, can be combined in any combination, with the exception of combinations in which at least some of these features and/or steps are mutually exclusive. The invention is not limited to the details of all of the preceding embodiments. The invention extends to any new feature, or any new combination, of the features disclosed in the present specification (including the claims, abstract and accompanying drawings), or to any new feature, or any new combination, of the steps of any method or process thus disclosed.

The readers attention is directed to all papers and documents which have been contemporaneously or previously filed with this specification in connection with this application and which are open to public inspection with this specification, and the contents of all such papers and documents are incorporated herein by reference.

### LIST OF REFERENCE NUMBERS

50 method of the invention
60 any symmetrical encryption process
61 symmetric encryption process key
62 plaintext message
63 encrypted message
64 converted symmetric encryption process
65 pseudorandom nonce
66 XOR operation
67 hash function
68 encrypted message
100 hash function
100a hash function
100b hash function
102 key used as boot value
104 pseudorandom nonce
106 pseudorandom nonce
108 XOR operation
108a XOR operation
108b XOR operation
110 intermediate pseudorandom number, M′
120 split
122 concatenation
124 concatenation
125 HMAC calculation(m, k)
500 computing device
502 processor
504 memory
506 communication module

1. A computer-implemented method for generating at least one pseudorandom number comprising:
obtaining a boot value, K, of a certain entropy represented by its bit length;
combining, by means of an XOR operation, the boot value, K, with a pseudorandom nonce, N, of the same bit length s, the combination represented by (K\hat{ }N) wherein \hat{ } is an XOR operation; and
running a one-way hash function, H, adapted to the bit length on the combination (K\hat{ }N) to generate a value, M′₀, wherein the pseudorandom number M′ᵢ₊₁ is calculated according to H(M′ᵢ), wherein 0≤i<n−1.

2. The method according to claim 1, comprising producing a sequence of pseudorandom masks Mᵢ using a sequence of pseudorandom numbers M′ᵢ and the nonce N for generating the pseudorandom numbers, according to the expression Mᵢ=H(M′ᵢ\hat{ }N), wherein 0≤i<n.

3. A method for encrypting a message, P, comprising the following steps:
splitting the message, P, into n equal parts, Pᵢ, wherein 0≤i<n, of the selected bit length s;
combining each part, Pᵢ, with the mask, Mᵢ of the same bit length s, wherein 0≤i<n, to form an encrypted part, C₀ to Cₙ₋₁, for each part; and
concatenating the nonce N and the encrypted parts, C₀ to Cₙ₋₁ to form an encrypted message, C, wherein each mask, M₀ to Mₙ₋₁, is a pseudorandom number generated according to the method of claim 2.

4. The method according to claim 3, wherein the combination comprises an XOR operation.

5. The method according to claim 3, comprising the creation of a signature, S, for the encrypted message C.

6. The method according to claim 5, comprising calculating the signature, S, according to HMAC(Sₙ₋₁, M′ₙ), wherein Sₙ₋₁ is the nth value in a sequence calculated according to sᵢ₊₁=Sᵢ\hat{ }Pᵢ₊₁, wherein 0≤i<n, S₀ is P₀ and wherein M′ₙ is n+1th value in the sequence of pseudorandom numbers M′ᵢ.

7. The method according to claim 5, comprising calculating the signature, S, according to HXOR(Sₙ₋₁, N), wherein sₙ₋₁ is the nth value in a sequence calculated according to sᵢ₊₁=Sᵢ\hat{ }Pᵢ₊₁, wherein 0≤i<n, S₀ is P₀ and N is the nonce.

8. The method according to claim 5, comprising attaching the signature, S, to the encrypted message C, to form a signed encrypted message, T.

9. The method for decrypting the encrypted message C, produced according to claim 3, comprising
retrieving the nonce N and the encrypted parts, C₀ to Cₙ₋₁ of the encrypted message C
producing a sequence of pseudorandom masks Mᵢ using a sequence of pseudorandom numbers M′ᵢ and the nonce N for generating the pseudorandom numbers, according to the expression Mᵢ=H(M′ᵢ\hat{ }N), wherein 0≤i<n;
decrypting each encrypted part C₀ to Cₙ₋₁, with the boot value, K and the nonce N, to form the equal parts, P₀ to Pₙ₋₁; and
combining parts P₀ to Pₙ₋₁ to form the message P.

10. A method for encrypting a data stream F, comprising:
slicing the data stream F into packets Pᵢ, of bit length s, with i≥0;
sending a pseudorandom nonce N in the encrypted stream ES;
encrypting each packet Pᵢ, wherein an encrypted packet C₂ᵢ=(Pᵢ\hat{ }M₂ᵢ) and C₂ᵢ₊₁=(Pᵢ\hat{ }M₂ᵢ₊₁), wherein Mᵢ is the sequence of pseudorandom masks Mᵢ according to claim 2;
concatenating the number i with to form C₂ᵢ and C₂ᵢ₊₁ to form the encrypted version (i|C₂ᵢ|C₂ᵢ₊₁); and
sending the encrypted version in the encrypted data stream ES.

11. A method for decrypting an encrypted data stream ES, produced according to claim 8, comprising:
retrieving the nonce N at the start of transmission of the encrypted data stream ES allowing calculation of the suites Mᵢ and M′_{I}, comprising producing a sequence of pseudorandom masks Mᵢ using a sequence of pseudorandom numbers M′ᵢ and the nonce N for generating the pseudorandom numbers, according to the expression Mᵢ=H(M′ᵢ\hat{ }N), wherein 0≤i<n;
decrypting each encrypted version (i|C₂ᵢ|C₂ᵢ₊₁) in Dᵢ=C₂ᵢ\hat{ }M₂ᵢ; and
the integrity check consisting of establishing that Dᵢ=M₂ᵢ₊₁\hat{ }C₂ᵢ₊₁, with the certainty that Dᵢ=Pᵢ, if this check is positive.

12. The method according to claim 1, wherein the hash function, H, has a quantum security level of more than 170 bits with respect to its inversion.

13. The method according to claim 1, wherein the hash function, H, is a Keccak hash function.

14. The method according to claim 1, wherein the selected bit length is 512 bits.

15. A computer-implemented method for symmetric encryption using a K key, comprising:
obtaining a pseudorandom nonce N for each plaintext message P to be encrypted, each nonce having the same bit length s as the K key;
combining, by means of an XOR operation, the K key with the nonce, N, the combination represented by (K\hat{ }N) wherein \hat{ } is an XOR operation;
running a one-way hash function, H, adapted to the bit length on the combination (K\hat{ }N) to generate a modified key, K′;
encrypting the message P using the modified key, K′; and
concatenating the nonce N to the result of this encryption to constitute the encrypted message C.

16. The computer-implemented method of symmetrically decrypting the encrypted message C according to claim 14, comprising:
obtaining the pseudorandom nonce N of the encrypted message C;
combining, by means of an XOR operation, the K key with the nonce, N, the combination represented by (K\hat{ }N) wherein \hat{ } is an XOR operation;
running the one-way hash function, H, on the combination (K\hat{ }N) to generate the modified key, K′; and
decrypting the encrypted message C using the modified key, K′, to obtain the plaintext message P.
